(19) United States
(12) Patent Application Publication
(10) Pub. No.: US 2010/0020936 A1
(43) Pub. Date: Jan. 28, 2010

(54) X-RAY TUBE

(76) Inventors: SVEN FRITZLER, Erlangen (DE); STEFAN POPESCU, Erlangen (DE); GEORG WITTMANN, Herzogenaurach (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/508,705

(22) Filed: Jul. 24, 2009

(30) Foreign Application Priority Data
Jul. 24, 2008 (DE) 10 2008 034 568.7

(51) Int. Cl. H01J 35/06; H01J 35/00

(52) U.S. Cl. 378/136; 378/121

(57) ABSTRACT

An x-ray tube has a vacuum housing supported so that it can rotate around a rotation axis, an anode that is arranged within the vacuum housing and that is connected in a rotationally fixed manner with the vacuum housing. The anode has an anode surface fashioned substantially in the shape of a ring. The center axis of which anode surface corresponds to the rotation axis. A cathode is mounted within the vacuum housing such that it can be rotated around the rotation axis. The cathode has a cathode surface fashioned substantially in the shape of a ring. The center axis of which cathode surface corresponds to the rotational axis. The cathode surface is arranged opposite the anode surface. A first actuator rotates the vacuum housing around the rotation axis with a first rotation speed ω₁. A second actuator rotates the cathode around the rotation axis with a second rotation speed ω₂, wherein ω₂<ω₁. A laser unit generates a laser beam that travels from outside the vacuum housing into the interior of the vacuum housing through a region of the vacuum housing that is transparent to the laser beam. Inside the vacuum housing, the laser beam strikes at a laser beam focal spot on the cathode surface, causing a thermionically induced emission of electrons at the laser beam focal spot on the cathode surface. The electrons are accelerated (by a high voltage that can be applied between the cathode and the anode) in the direction of the anode surface in order to generate x-ray radiation upon striking an electron beam focal spot on the anode surface.

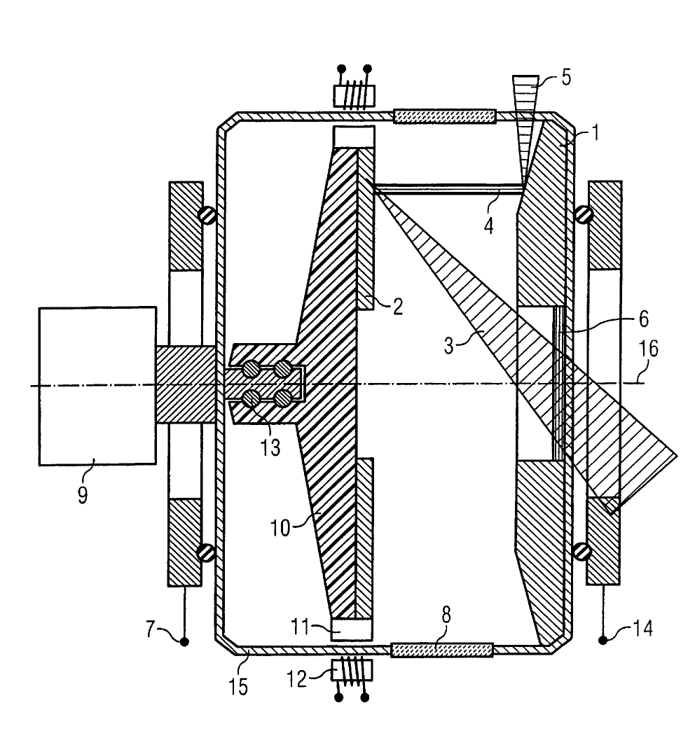

### BACKGROUND OF THE INVENTION

1. Field of the Invention

The present invention concerns an x-ray tube of the type having a vacuum housing that is supported such that it can be driven and rotated around a rotation axis, in which vacuum housing is arranged an electron-emitting cathode and a ring-shaped or plate-shaped anode connected in a rotationally fixed manner with the vacuum housing, the center axis of the anode corresponding to the rotation axis; wherein the electrons emitted by the cathode as an electron beam strike the anode at an electron beam focal spot. Such x-ray tubes are generally known and serve to generate x-rays for the examination of subjects. They are in particular used in computed tomography in medical technology.

2. Description of the Prior Art

In the prior art, an x-ray tube is known with the features described above, this x-ray tube having an annular or plate-shaped cathode arranged opposite the annular anode in a rotatable vacuum housing. The center axes of the cathode and of the anode respectively coincide with the rotation axis of the vacuum housing, and both the cathode and the anode are connected in a rotationally fixed manner with the vacuum housing. The cathode and the anode thus always rotate in the same direction and in sync with the vacuum housing around the rotation axis. In operation of the x-ray tube, the cathode is locally heated by a laser beam so that a thermionic emission occurs. The laser beam strikes a stationary laser beam focal spot on the cathode and thus the cathode essentially rotates under the stationary laser beam focal spot. The electrons arising at the laser beam focal spot are accelerated (by a high voltage that can be applied between cathode and anode) toward the anode and strike the anode at a stationary electron beam focal spot on the anode.

### SUMMARY OF THE INVENTION

An object of the present invention is to provide an x-ray tube of the type described above such that a higher x-ray power can be achieved and the laser power required for local emission of electrons at the cathode is minimized. Furthermore, it should be possible to operate the x-ray tube in a more cost-effective manner.

The above object is achieved in accordance with the present invention by an x-ray tube having a vacuum housing that is supported that it can rotate around a rotation axis, and an anode that is in the vacuum housing that is connected in a rotationally fixed manner with the vacuum housing, the anode having an anode surface fashioned substantially in the shape of a ring. The center axis of the anode surface coincides with the rotation axis. The x-ray tube has a cathode that is supported in the vacuum housing so that it can rotate around the rotation axis, the cathode having a cathode surface fashioned substantially in the shape of a ring. The center axis of which cathode surface also coincides with the rotation axis, and the cathode surface is arranged opposite the anode surface. A first actuator (drive) rotates the vacuum housing around the rotation axis with a first rotation speed ω₁. A second actuator rotates the cathode around the rotation axis with a second rotation speed ω₂, wherein ω₂<ω₁. A laser unit generates a laser beam that travels from outside the vacuum housing into the interior of the vacuum housing through a region of the vacuum housing that is transparent to the laser beam, and inside the vacuum housing the laser beam strikes the cathode surface at a laser beam focal spot thereon. A thermionically induced emission of electrons is generated by the laser beam at the laser beam focal spot on the cathode surface, and the electrons that are thereby generated are accelerated (by a high voltage that can be applied between cathode and anode) in the direction of the anode surface in order to generate x-ray radiation upon striking an electron beam focal spot on the anode surface.

The present invention is based on the insight that, starting from the prior art described above, it is advantageous for the laser-heated cathode (which is fashioned substantially in a ring shape) to rotate more slowly around the common rotation axis than the associated anode (also fashioned substantially in a ring shape). The laser power required for thermionic emission can be reduced by such a slower rotation of the laser-heated cathode, since the heat can be more effectively locally introduced at a lower cathode rotation speed. In addition, electrical power for the operation of the laser unit can be saved due to the lower laser power that is required, which reduces the overall cost of the operation of the x-ray tube according to the invention. At the same time, a correspondingly greater x-ray power can be generated by the faster rotation of the anode and the resulting decrease of the anode temperature at the electron beam focal spot.

The rotation of the anode on the common rotation axis is therefore decoupled from the rotation of the cathode in the x-ray tube according to the invention. The design of the anode and the cathode as being substantially ring shaped encompasses, in addition to an annular shape, other rotationally symmetric shapes (for example plate-shaped forms).

A predeterminable, individual adjustment and regulation of the first rotation speed ω₁ for the anode, or of the vacuum housing connected thereto, and of the second rotation speed w₂ for the cathode is achieved by the decoupling of the rotation of cathode and anode, allowing ω₂<ω₁ to be reasonably selected. The rotation speed of the cathode can be optimally adapted to the cathode material for a given laser power. Moreover, the laser power can also be optimized dependent on the cathode material for a given rotation speed ω₂. It should be noted that the rotation of anode and cathode around the common rotation axis can ensue in the same direction as well as in opposite directions, i.e., ω₁ and ω₂ in the indicated relations are only the magnitudes (absolute values) of the respective rotation speeds: thus ω₁=|ω₁| and ω₂=|ω₂|.

The rotation speed of the anode is typically significantly higher than the rotation speed of the cathode, i.e. ω₁>>ω₂. In an extreme case the cathode (although still rotationally mounted) can be intentionally not rotated, so that its rotational speed is equal to 0 (ω₂=0). In this special case, the cathode rotates with the negative anode rotation speed relative to the anode so that a laser beam that strikes the cathode in a stationary laser beam focal spot heats the cathode with maximum efficiency.

For this special case the second actuator is advantageously controlled such that the cathode is stationary (ω₂=0) relative to the rotation axis during an operating cycle (scan) until its end and is repositioned via a rotation around the rotation axis before a further operating cycle (scan), such that the laser beam focal spot that is stationary relative to the rotation axis strikes at a different point of the cathode surface. A local overheating of the cathode material thus can be prevented.

According to the invention, the laser beam that serves to locally heat the cathode is generated by the laser unit. Optical means for laser light conduction and deflection between laser unit and laser beam focal spot can be provided outside and/or inside the vacuum housing. The laser unit is furthermore advantageously arranged to be stationary, in particular stationary relative to the rotation axis. The term “rotation axis” does not mean a rotating physical axle but rather means an abstract straight line that does not itself rotate. Thus, the stationary arrangement of the laser unit of relative to the rotation axis means that the position of the laser unit in space is relative to the abstract rotation axis (for example defined by cylindrical coordinates z, r, φ. A rotation of this position thus does not occur even though it is defined relative to the rotation axis. This also applies to other specifications of a position defined relative to the rotation axis.

The first actuator provided for the rotation of the vacuum housing is advantageously an electromotor. Naturally, other alternative actuators known to those skilled in the art can be used, for example a pneumatic actuator. The second actuator can be executed as an asynchronous motor or as a synchronous motor, in particular as a step motor. In one embodiment the second actuator can furthermore be designed such that, given a rotation of the vacuum housing or of the anode with a first rotation speed ω₁, the cathode can be kept stationary (ω₂=0) relative to the rotation axis by means of the second actuator. In this case the cathode is essentially held in place by the second actuator. Details as to how such a first or second actuator can be made to operate as described herein are known to those skilled in the art.

In an additional embodiment of the x-ray tube according to the invention, a focusing device is provided with which the laser beam is focused on a predeterminable laser beam focal spot on the cathode surface. This focusing device can be a component of the laser unit or can be provided as a separate optical unit outside of or inside the vacuum housing.

In a particularly preferred embodiment of the x-ray tube according to the invention, the laser beam strikes at a stationary laser beam focal spot on the cathode surface. In normal operation (ω₂>0) the cathode surface is thus rotated beneath the laser beam focal spot (which is stationary relative to the rotation axis). The positioning of the laser beam focal spot on the cathode surface can ensue with very high precision, which overall contributes to an increase in the focus stability of the x-ray tube.

In a preferred embodiment, the region of the vacuum housing that is transparent to the laser beam is fashioned to be rotationally symmetric around the rotation axis in the region of the anode. The anode thereby overlaps the transparent region inside the vacuum housing. Furthermore, the anode has a passage therein that is arranged congruent or nearly congruent with the transparent region. The laser beam thus can be deflected from outside the vacuum housing, through the transparent region and through the passage in the anode, directly onto the cathode, without being affected by a rotation of the vacuum housing. In a further embodiment, the passage in the anode can be at least partially filled with a material transparent to the laser beam.

A control unit is provided to control the first and second actuators. In the simplest case, the rotation speed of anode and cathode can be individually predetermined, regulated and monitored by this control unit. The control unit can additionally control and monitor the laser unit, in particular the laser power generated by the laser unit. In principle, the laser power can be controlled more precisely and quickly than, for example, the heat power of a conventional, electrically operated thermionic cathode with spiral-wound filament, such that the laser-heated cathode also has a more precise and faster control capability. The rotation speeds ω₁, ω₂ and the laser power thus can be optimized with regard to the x-ray power to be generated, the necessary laser power and the anode and cathode materials that are used.

An additional improvement of the x-ray power that can be generated with the x-ray tube according to the invention is possible by cooling of the anode. For a given electron flow from cathode to anode, a cooling of the anode (as is known) enables an increase of the x-ray power that can be generated due to the lower anode temperature. In a further preferred embodiment, the anode is therefore in direct or indirect heat-conducting contact (thermal communication) with a heat sink. Such a heat sink can be a cooling circuit with a coolant circulating therein. In another embodiment a protective housing is provided that surround the vacuum housing and is filled with insulating oil, in which the vacuum housing is mounted such that it can rotate around the rotation axis, and such that the insulating oil serves as a coolant.

The first actuator and second actuator are advantageously arranged and electromagnetically shielded such that electromagnetic influence on the electron beam due to the activation and operation of the actuators is negligibly small.

An advantage of the x-ray tube according to the invention is the ability to adjust the optimal rotation frequency of anode and cathode in order to generate optimally high electron currents from cathode to anode at low laser powers. Furthermore, emitters of different efficiency can be adapted to a predetermined laser power through optimal adjustment of the rotational frequency of the cathode. A significant increase of the cathode service life can additionally be achieved by the use of a laser-heated cathode with an optimally large area.

### BRIEF DESCRIPTION OF THE DRAWINGS

The single FIGURE is a schematic, longitudinal section through an x-ray tube according to the invention.

### DESCRIPTION OF THE PREFERRED EMBODIMENTS

The FIGURE shows an example of the design of an x-ray tube according to the invention in longitudinal section, i.e. along the rotation axis 16. The shown x-ray tube has a vacuum housing 15 that is supported (mounted) such that it can rotate on the rotation axis 16. An anode 1 is arranged inside the vacuum housing 15 and is connected with the vacuum housing 15 such that it is rotationally fixed thereto. The anode 1 has an anode surface fashioned generally in the shape of a ring. The middle axis of the anode 1 surface corresponds to the rotation axis 16. A cathode 2 is provided inside the vacuum housing 15 and can be rotated around the rotation axis 16 relative to the vacuum housing 15. The cathode 2 likewise has a cathode surface fashioned generally in the shape of a ring, the middle axis of which corresponds to the rotation axis 16. The cathode surface is arranged opposite the anode surface. The cathode 2 is mounted on a plate-shaped cathode mount 10 that is held in a free-running ball bearing 13. A first actuator 9 is provided to rotate the vacuum housing 15 on the rotation axis 16. A second actuator 11, 12 is provided to rotate the cathode 2 on the rotation axis 16 independent of the vacuum housing 15 and the anode 1. The second actuator in this embodiment is fashioned as a step motor with permanent magnets 11 mounted on the peripheral edge of the cathode ring 2 or of the cathode mount 10, and coils 12 arranged in the same plane outside of the vacuum housing 15. The coils can be mounted outside of the vacuum housing 15 or be arranged stationary relative to the rotation axis and spaced apart from said vacuum housing 15.

The rotationally symmetrical vacuum housing 15 has an insulation ring 8 produced from ceramic material and that electrically insulates the two remaining housing walls (which are produced from metal) from one another. In the figure, the housing walls of the vacuum housing 15 that are shown in black are produced from metal. The feed of the high voltage to the anode and cathode ensues via respective electrical contacts 7 and 14.

A laser unit (not shown) arranged to be stationary relative to the rotation axis 16 is arranged outside of the vacuum housing 15, with which laser unit a laser beam 3 can be generated that strikes the cathode surface 2 from outside the vacuum housing 15 through a region 6 of the vacuum housing 15 that is transparent to the laser beam 3. The anode 1 has a cylindrical passage (hole) coaxial to the rotation axis 16. This passage is congruent or nearly congruent with the transparent region 6 of the vacuum housing 15. The laser beam focal spot on the cathode surface in this embodiment stationary relative to the rotation axis 16.

A thermionically induced emission of electrons ensues at the point of incidence of the laser beam 3 on the cathode surface. The electrons that are thereby generated are accelerated in the direction of the anode surface by a high voltage applied between the cathode 2 and the anode 1 in order to generate x-rays 5 upon the electrons striking the anode surface. The laser power and/or the rotation frequency of the cathode are naturally selected such that a heat input sufficient for thermionic electron emission occurs at the point of incidence of the laser beam 3 on the cathode surface.

Although modifications and changes may be suggested by those skilled in the art, it is the intention of the inventors to embody within the patent warranted hereon all changes and modifications as reasonably and properly come within the scope of their contribution to the art.

We claim as our invention:

1. An x-ray tube comprising:
a vacuum housing mounted to rotate around a rotation axis;
an anode in said vacuum housing, said anode being connected to said vacuum housing by a rotationally fixed connection so said anode co-rotates with said vacuum housing, said anode having a substantially ring-shaped anode surface having a center axis that coincides with said rotation axis;
a cathode mounted in said vacuum housing by a rotational mount that allows said cathode to rotate around said rotation axis, said cathode having a substantially ring-shaped cathode surface having a center axis that coincides with said rotation axis, said cathode surface being located opposite said anode surface;
a first actuator connected to said vacuum housing that rotates said vacuum housing around said rotation axis with a first rotation speed ω₁;
a second actuator connected to said cathode to rotate said cathode around said rotation axis with a second rotation speed ω₂, wherein ω₂<ω₁; and
a laser unit located outside of said vacuum housing, said laser unit emitting a laser beam and said vacuum housing having a housing region that is transparent to said laser beam, said laser beam proceeding from said laser unit outside of said vacuum housing through said housing region into an interior of said vacuum housing and striking at a laser beam focal spot on said cathode surface to cause thermionically-induced emission of electrons from said laser beam focal spot, said cathode surface and said anode surface being situated relative to each other in said vacuum housing to cause said electrons to strike said anode surface at an electron beam focal spot to cause x-ray radiation to be emitted from said anode surface at said electron beam focal spot.

2. An x-ray tube as claimed in claim 1 comprising a high voltage system that applies a high voltage between said cathode and said anode that accelerates said electrons from said cathode surface onto said anode surface.

3. An x-ray tube as claimed in claim 1 wherein said laser unit is stationary relative to said rotation axis.

4. An x-ray tube as claimed in claim 1 comprising a focusing device configured to interact with said laser beam to focus said laser beam to a predetermined laser beam focal spot on said cathode surface.

5. An x-ray tube as claimed in claim 1 wherein said laser beam strikes a stationary laser beam focal spot on said cathode surface.

6. An x-ray tube as claimed in claim 1 wherein said housing legion is rotationally symmetric around said rotation axis between said anode and said cathode, said anode overlapping said housing region and having a passage therein substantially congruent with said housing region that allows passage of said laser beam therethrough.

7. An x-ray tube as claimed in claim 6 wherein said passage in said anode is at least partially filed with a material that is transparent to said laser beam.

8. An x-ray tube as claimed in claim 1 wherein said first actuator is an electromotor.

9. An x-ray tube as claimed in claim 1 wherein said actuator is a motor selected from group consisting of a synchronous motor and synchronous motors.

10. An x-ray tube as claimed in claim 1 wherein said second actuator is a stepper motor.

11. An x-ray tube as claimed in claim 1 comprising a control unit connected to said first actuator, said second actuator and said laser unit, said control unit being configured to operate each of said first and second actuators to rotate said vacuum housing and said cathode, respectively, and to operate said laser unit to emit said laser beam.

12. An x-ray tube as claimed in claim 11 wherein said control unit is configured to selectively set a laser power of said laser beam.

13. An x-ray tube as claimed in claim 1 wherein said second actuator is configured to hold said second rotation speed ω₂=0 while said first rotation speed ω₁>0.

14. An x-ray tube as claimed in claim 1 comprising a heat sink in thermal communication with said anode.

15. An x-ray tube as claimed in claim 14 wherein said heat sink comprises a cooling circuit with a coolant circulating therein.

16. An x-ray tube as claimed in claim 1 comprising a protective housing surrounding said vacuum housing and an insulating oil filling said protective housing around said vacuum housing, said vacuum housing rotating in said protective housing around said rotation axis with said insulating oil cooling said vacuum housing.

17. An x-ray tube as claimed in claim 1 comprising an electromagnetic shielding that shields each of said first actuator and said second actuator from said electrons to reduce electromagnetic influencing of said electron beam by said first actuator and said second actuator.
